(19) United States
(12) Patent Application Publication
(10) Pub. No.: US 2026/0326836 A1
(43) Pub. Date: Oct. 22, 2026

(54) VEHICLE WITH A CAB MOUNTING SYSTEM WITH A PASSIVE PRESSURISED AIR GENERATOR

(71) Applicant: ZF FRIEDRICHSHAFEN AG, Friedrichshafen (DE)

(72) Inventors: Manuel BEHNER, Lenggries (DE); Alfred MEMMEL, Schonungen (DE); Thomas NOWOTKA, Bundorf (DE)

(21) Appl. No.: 19/101,416

(22) PCT Filed: Aug. 4, 2023
(86) PCT No.: PCT/EP2023/071666

§ 371 Date: Feb. 5, 2025

(30) Foreign Application Priority Data
Aug. 8, 2022 (DE) 10 2022 208 208.7

(51) Int. Cl. B62D 33/06; B62D 24/04; B62D 33/067; B62D 33/073; F04B 19/04; F16F 15/023; F16F 15/027

(52) U.S. Cl. CPC B62D 33/0608; B62D 24/04; B62D 33/067; B62D 33/073; F04B 19/04; F16F 15/0232; F16F 15/0275; F16F 2222/126; F16F 2228/066; F16F 2230/183; F16F 2232/08

(57) ABSTRACT

A vehicle that has a vehicle frame and a vehicle cabin movably mounted relative to the vehicle frame, with a cabin mounting system, which cabin mounting system has at least one air spring arranged between the vehicle frame and the vehicle cabin. An air mass in the air spring is variably adjustable via a valve unit. The cabin mounting system has a position sensing system for detecting a relative position between the vehicle cabin and the vehicle frame and has a controller configured to control the valve unit of the air spring based on the relative position. The cabin mounting system has at least one passive compressed air generator formed to deliver air mass for the air spring based on a relative movement between the vehicle frame and the vehicle cabin.

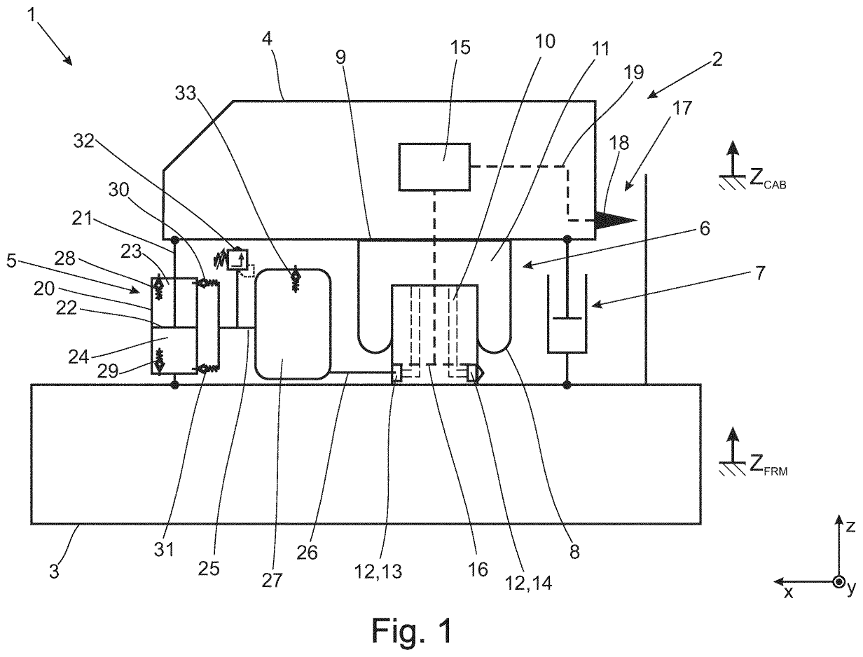

### CROSS REFERENCE TO RELATED APPLICATIONS

This is a U.S. national stage of Application No. PCT/EP2023/071666 filed Aug. 4, 2023. Priority is claimed on German Application No. DE 10 2022 208 208.7 filed Aug. 8, 2022 the content of which is incorporated herein by reference.

### BACKGROUND OF THE INVENTION

### 1. Field of the Invention

The disclosure is directed to a vehicle having a cabin mounting system to shield against vibrations and/or for changing the attitude of the vehicle cabin in relation to the vehicle frame.

### 2. Description of the Related Art

Mounting systems for springing, vibration-damped mounting of a driver's cab relative to the vehicle frame which serve to improve comfort during a driving operation are known particularly in the field of utility vehicles. The mounting system is usually implemented by air springs arranged between the driver's cab and vehicle frame. The air springs are connected to an air supply. The air supply is generally realized via an air mass storage which is located in the vehicle and which is generally formed as an accumulator which is filled with air mass by a compressor and provides the air supply for the individual air springs via a control. To this end, the compressor must be fed with electrical energy.

DE 10 2013 009 204 A1 describes a system for the level control of a driver's cab of a utility vehicle relative to a vehicle chassis and a corresponding operating method. The system comprises a sprung mounting for springing support of the driver's cab on the vehicle chassis, distance sensor(s), which are adapted to detect relative movements and/or a distance between the driver's cab and the vehicle chassis, and controller configured for variable actuation of the sprung mounting. Signals of the distance sensor are used for actuating the sprung mounting. The sprung mounting is adjustable to a first height position so that the distance between the driver's cab and vehicle chassis is controlled by the controller to a first reference distance. The sprung mounting is adjustable to at least a second height position so that the distance between the driver's cab and the vehicle chassis is controlled by the controller to a second reference distance, and the controller adjusts the sprung mounting to the first height position or to the at least one second height position depending on at least one parameter pertaining to a driving distance and/or a vehicle state.

### SUMMARY OF THE INVENTION

It is an object of one aspect of the invention to provide a cabin mounting system of the type mentioned above which is characterized by a low energy consumption and a cost-efficient construction.

A vehicle with a vehicle frame and a vehicle cabin, which vehicle cabin is movable relative to the vehicle frame. By “vehicle cabin”, also known as driver's cab, is meant the portion of the vehicle body that forms a space for the driver of the vehicle and possibly one or more passengers. By “vehicle frame”, also known as chassis, is meant the portion of the vehicle body that receives or carries the drive, the vehicle cabin and useful loads, if any.

The vehicle has a cabin mounting system, particularly a pneumatic cabin mounting system. In particular, the cabin mounting system serves to shield against vibrations and/or for changing the attitude of the vehicle cabin in relation to the vehicle frame.

The cabin mounting system has at least one, or exactly one, air spring arranged between the vehicle frame and the vehicle cabin. The air spring has the function of influencing the suspension characteristics and/or the attitude of the vehicle cabin relative to the vehicle frame by changing the air volume and/or air mass of the air spring. In principle, the vehicle cabin can be supported at the vehicle frame exclusively via the at least one air spring. Alternatively, the vehicle cabin is additionally supported or mounted at the vehicle frame via at least one damping element and/or a spring element and/or a bearing element. In particular, it is provided that the cabin mounting system has at least two, or exactly two, air springs, at least one of the air springs being arranged on each side of the vehicle. The air spring is substantially formed by a roll bellows which is connected in an airtight manner to a receiving plate on the one side and to a roll-off piston on the other side.

The cabin mounting system has a valve unit which is formed and/or suitable for variable adjustment of the air mass in the air spring. In principle, the valve unit is integrated in the air spring. Alternatively, the valve unit can also be formed as a central valve unit which serves for variable adjustment of the air mass of two or more air springs. By the valve unit in at least one of the air springs, the air mass can preferably be increased in order to raise the air spring and vehicle cabin, respectively, or reduced in order to lower the air spring and vehicle cabin, respectively. In particular, the air spring is provided with an air mass for this purpose which is supplied to or removed from the air spring via the valve unit.

The cabin mounting system has a position sensing system, which is formed and/or suitable for detecting a relative position between the vehicle cabin and the vehicle frame. In particular, the position sensing system is formed to detect a distance and/or a movement and/or a tilt of the vehicle cabin relative to the vehicle frame, particularly during a driving operation. For this purpose, the position sensing system can have, for example, a position sensor and/or a tilt sensor and/or an acceleration sensor. The position sensing system is preferably formed to detect an absolute position or relative position of the vehicle cabin.

The cabin mounting system has a controller formed to control the valve unit of the air spring based on the detected relative position and/or absolute position. In particular, the controller is formed as an electronic controller (ECU). The controller can be formed as a vehicle control device or can at least be integrated in the vehicle control device. Alternatively, the controller can also be formed by a separate control device which is connected to the vehicle control device, for example, via a bus system, e.g., CAN bus. In particular, the controller is formed to lower or raise the vehicle cabin and the air spring depending on the relative position and/or to increase or reduce the air mass in the air spring. The controller is particularly preferably signally connected to the position sensing system and the valve unit.

The cabin mounting system has at least one, or exactly one, passive compressed air generator formed to deliver an air mass in the form of compressed air for the at least one air spring based on a relative movement between the vehicle frame and the vehicle cabin, particularly during the driving operation. In particular, the vehicle is formed as a vehicle without an electrically driven compressor, and the air mass required for the air spring is delivered exclusively or for the most part through the passive compressed air generator. The compressed air generator is preferably movement-coupled with the vehicle frame and vehicle cabin in such a way that the relative movement occurring in driving operation between the vehicle cabin and the vehicle frame can be utilized as an energy source for delivering the air mass for at least one air spring.

Accordingly, a pneumatic cabin mounting system is proposed, which utilizes movement energy for delivering the air mass so that it need no longer be actively supplied with energy. Accordingly, the cabin mounting system can be operated in a particularly energy-efficient and autonomous manner. A further advantage consists in that the passive compressed air generator can be constructed appreciably simpler and more economically than a compressor that is usually installed in the vehicle.

In an advantageous configuration, it is provided that the compressed air generator is movement-coupled with the vehicle frame and vehicle cabin in such a way that the compressed air generator delivers the air mass during a relative rolling motion between the vehicle frame and vehicle cabin, particularly around a vehicle longitudinal axis (x axis). Alternatively or optionally additionally, it is provided that the compressed air generator is movement-coupled with the vehicle frame and vehicle cabin in such a way that the compressed air generator delivers the air mass during a relative pitching motion between the vehicle frame and vehicle cabin, particularly around a vehicle transverse axis (y axis). In particular, to this end, the compressed air generator is arranged off-center between the vehicle cabin and the vehicle frame particularly with respect to the vehicle longitudinal axis and/or the vehicle transverse axis. Optionally, the cabin mounting system can have at least one further compressed air generator. The one compressed air generator is formed or arranged to generate compressed air during the relative rolling motion, and the other compressed air generator is formed or arranged to generate compressed air during the relative pitching motion. Accordingly, a compressed air generator is proposed which can be integrated in a simple manner between the vehicle frame and the vehicle cabin by utilizing different relative movements for compressed air generation.

In a further constructional variant, it is provided that the compressed air generator is formed as an air pump which is coupled with the vehicle frame on one side and with the vehicle cabin on the other side. In particular, the relative movement is translated into a working movement of the air pump in order to deliver an air mass located in the air pump and supply it at least indirectly to the air spring. In particular, the air spring is pneumatically connected to the air pump, particularly to at least one working chamber of the air pump. In principle, the air mass supplied by the air pump can be supplied to the valve unit directly or indirectly via an air mass storage as will be explained in more detail in the following. Accordingly, a compressed air generator is suggested which is characterized by a particularly simple and economical construction and, further, can be integrated between the vehicle frame and vehicle cabin in a simple manner.

In a further aspect, it is provided that the compressed air generator has a cylinder and a piston which is guided in the cylinder via a piston rod and which divides the cylinder into a first working chamber and a second working chamber. In particular, the compressed air generator is formed at least as a single-acting piston air pump. The piston rod is preferably connected at one end to the piston and at the other end to the vehicle frame or vehicle cabin selectively via a connection interface. Correspondingly, the cylinder can be connected selectively to the vehicle cabin or the vehicle frame on a side remote of the piston rod via a further connection interface. In particular, the first working chamber is to be understood as a working chamber on the piston rod side and the second working chamber is to be understood as a working chamber remote of the piston rod.

According to this constructional variant, at least one of the working chambers is connected to an environment via an inlet valve and the other working chamber is connected at least indirectly to the air spring via an outlet valve. In particular, the relative movement between the vehicle cabin and the vehicle frame is translated into a lifting movement of the piston, and the air mass is delivered based on the lifting movement, particularly during an inward movement and/or outward movement of the piston rod. In principle, the at least one inlet valve/outlet valve can be integrated in the cylinder. Alternatively, the at least one inlet/outlet valve can also be formed separate from the air pump and/or incorporated fluidically upstream or downstream of the air pump. Accordingly, a passive compressed air generator is proposed which is characterized by a particularly simple and robust construction.

In a further aspect, it is provided that the compressed air generator is formed as a double-acting piston air pump. By “double-acting” is meant in particular that the air pump delivers the air mass during a rebound movement as well as during a compression movement or when the piston rod moves in and when the piston rod moves out, respectively. To this end, the compressed air generator has a first inlet valve and a second inlet valve and a first outlet valve and a second outlet valve. The first working chamber is connected to the environment via the first inlet valve and is at least indirectly connected to the air spring via the first outlet valve. The second working chamber is connected to the environment via the second inlet valve and is at least indirectly connected to the air spring via the second outlet valve. During a compression movement, i.e., when the piston rod moves into the cylinder, the air mass flows out of the environment via the first inlet valve into the first working chamber and, at the same time, the air mass located in the second working chamber is compressed and flows out via the second outlet valve as the air mass flow. During a rebound movement, i.e., when the piston rod moves out of the cylinder, the air mass flows out of the environment via the second inlet valve into the second working chamber and, at the same time, the air mass located in the first working chamber is compressed and flows out via the first outlet valve as air mass flow. The first inlet valve and second inlet valve and/or the first outlet valve and second outlet valve are preferably formed as a spring-loaded check valve which opens and closes automatically depending on the lift movement. Accordingly, an air pump is suggested which is characterized by a steady air mass delivery during the relative movement and can accordingly be operated particularly efficiently.

In a further development, it is provided that the cabin mounting system has an air mass storage which is formed and/or suitable for intermediate storage of the air mass generated by the compressed air generator. In particular, the air mass storage has the function of storing the air mass delivered by and supplied from the compressed air generator and providing it to the air spring via the valve unit. In particular, the air mass storage is fluidically arranged between the air pump and the air spring for this purpose. In this respect, the air mass storage is pneumatically connected to the compressed air generator via an input-side compressed air line and to the air spring via an output-side compressed air line. In particular, the air mass storage is formed as an accumulator. The air mass storage can be formed, for example, as a central air mass storage, and the one or more air springs can be supplied with air mass through the air mass storage. In particular, the air mass storage can be configured in such a way that the air spring can be raised at least once, in particular in a pressureless state. In principle, the air mass storage can be arranged at any location in the vehicle, e.g., the vehicle frame or the vehicle cabin. However, the air mass storage is preferably arranged between the vehicle frame and the vehicle cabin, in particular adjacent to the compressed air generator and/or the air spring. Accordingly, a cabin mounting system is suggested which is characterized by a high operating reliability, and a compressed air supply can be ensured by the air mass storage over a limited period of time, particularly when the vehicle is at a standstill.

In an advantageous implementation, it is provided that the at least one outlet valve, preferably the first outlet valve and/or the second outlet valve of the compressed air generator, is connected to the air mass storage via the input-side compressed air line. In particular, the first outlet valve and the second outlet valve are connected to the air mass storage via a common compressed air line. Alternatively, the first outlet valve and the second outlet valve can also be connected to the air mass storage via a separate compressed air line, respectively. Accordingly, a cabin mounting system is proposed which is particularly easy to install.

In a further advantageous construction, it is provided that the air mass storage has a filling valve which is formed and/or suitable for external filling and/or for pre-filling of the air mass storage with air mass. In particular, the filling valve is used for connecting a compressed air source for supplying air mass from the outside. For example, the filling valve is formed as a spring-loaded check valve which has a compressed air connection for connecting the compressed air source. In particular, the filling valve is accessible from the outside in case the air mass storage is installed in the vehicle so that the air mass storage can be refilled with air mass when needed.

In a further configuration, it is provided that the valve unit of the air spring has an inlet valve and an outlet valve, and the controller is formed to actuate the inlet valve or the outlet valve for raising or lowering the air spring. Simply put, the inlet valve is actuated to supply air mass to the air spring for lifting, the outlet valve being closed simultaneously. Correspondingly, the outlet valve is opened to remove air mass for lowering the air spring, the inlet valve being closed simultaneously. In principle, the inlet valve and/or the outlet valve are formed as a switching valve with discrete switching states, preferably exactly two switching states.

Alternatively, the inlet valve and/or the outlet valve can also be formed as a proportional valve, particularly a throttle valve, with continuous switching states. Particularly preferably, the inlet valve and the outlet valve are electrically controllable by the controller. The inlet valve and the outlet valve can be connected to the controller via a signal line for this purpose. Accordingly, an air spring is suggested which is characterized by a simple actuation and an economical construction.

In a further construction, it is provided that the inlet valve of the air spring is directly connected to the air mass storage via the output-side compressed air line. In particular, each of the air springs has a separate inlet valve, and all of the inlet valves are connected in common to the air mass storage via the output-side compressed air line. In principle, the inlet valves can be formed as individual inlet valves integrated in the respective air springs. Alternatively, however, the inlet valves can also be collectively combined to form a valve block. Further, it can be provided that the outlet valve of the air spring is selectively connected to the air mass storage or to the environment. Accordingly, a cabin mounting system is proposed which is characterized by a simple connection of the air spring or of the plurality of air springs.

In a further configuration, it is provided that the cabin mounting system has an overpressure valve. In particular, the overpressure valve is formed to protect the air mass storage and/or the air spring from an impermissible pressure increase. To this end, the overpressure valve can open upon reaching a fixed response pressure so that the air mass is discharged into the environment via the overpressure valve until a fixed closing pressure has been reached. The overpressure valve is connected between the compressed air generator and the air spring, particularly between at least one outlet valve of the compressed air generator and the inlet valve of the air spring. In particular, the overpressure valve is selectively connected according to at least one outlet valve to the compressed air generator or to the input-side compressed air line or to the air mass storage. Accordingly, a cabin mounting system is proposed which is characterized by a particularly reliable operating behavior and a simple monitoring of the air pressure.

In a further development, it is provided that the controller is formed to implement a level control and/or a tilt control of the vehicle cabin by controlling and/or regulating the valve unit based on the relative position. The controller can advantageously be formed to increase the distance and/or the tilt or a tilt angle of the vehicle cabin relative to the vehicle frame by supplying air mass to the air spring or to reduce the distance and/or the tilt or a tilt angle of the vehicle cabin relative to the vehicle frame by removing air mass from the air spring in order to change the level and/or the tilt of the vehicle cabin relative to the vehicle frame.

In a further alternative implementation, it can be provided that the cabin mounting system has at least one, or exactly one, vibration damper which is formed and/or suitable for vibration-damped support of the vehicle cabin at the vehicle frame. The vibration damper can be formed as a hydraulic damper or gas pressure damper. In particular, the vibration damper is arranged between the vehicle frame and the vehicle cabin. The vibration damper is coupled with the vehicle frame on one side and with the vehicle cabin on the other side. The vibration damper is preferably swivelably mounted at the vehicle cabin and/or at the vehicle frame. In particular, at least one vibration damper can be provided for each air spring. In principle, at least one vibration damper can be arranged on each side of the vehicle. In particular, exactly two of the vibration dampers and/or two of the air springs can be arranged on each side of the vehicle. In this regard, two of the vibration dampers or air springs, respectively, can be arranged in a front area of the vehicle or vehicle cabin and two of the vibration dampers and/or air springs, respectively, can be arranged in a rear area of the vehicle or vehicle cabin.

In a further exemplary implementation, it is provided that the compressed air generator is arranged in a front area and the vibration damper is arranged in a rear area considered in driving direction. Alternatively, the at least one vibration damper can also be arranged in the front area and the at least one compressed air generator can be arranged in the rear area. In particular, the at least one air spring can be arranged between the compressed air generator and the vibration damper considered in driving direction. In particular, a vibration damper, an air spring and a compressed air generator, respectively, can be arranged on each side of the vehicle, namely, in a mirror-symmetrical manner relative to one another with respect to a vehicle longitudinal axis. Accordingly, a cabin mounting system is proposed which is characterized by vibration-damped mounting and a simple transfer of the relative movement to the compressed air generator.

In a further configuration, it is provided that the vehicle is a utility vehicle, for example, a truck, or an agricultural machine, for example, a tractor, or a construction machine, for example, a wheel loader.

### BRIEF DESCRIPTION OF THE DRAWING

Further features, advantages and effects of the invention will be apparent from the following description of preferred exemplary embodiments of the invention. The drawing shows:

The Figure is a schematic depiction of a vehicle with a cabin mounting system;

### DETAILED OF THE PRESENTLY PREFERRED EMBODIMENTS

The Figure is a schematic depiction of a vehicle 1 with a cabin mounting system 2, for a utility vehicle, e.g., a truck.

The vehicle 1 has a vehicle frame 3 and a vehicle cabin 4. The vehicle cabin 4 is movable relative to the vehicle frame 3. In addition to driving comfort, the cabin mounting system 2 ensures the relative position of the vehicle cabin 4 with respect to the vehicle frame 3.

To this end, the mounting system 2 has at least one controlled air spring 6 and at least one vibration damper 7, which serve for vibration-damped support of the vehicle cabin 4 at the vehicle frame 3. To this end, the air spring 6 and the vibration damper 7 are arranged, respectively, between the vehicle frame 3 and the vehicle cabin 4 and are coupled with the vehicle frame 3 on one side and with the vehicle cabin 4 on the other side.

The air spring 6 substantially comprises a roll bellows 8, a receiving plate 9 and a roll-off piston 10 which are connected to one another in an airtight matter and define an air chamber 11. The receiving plate 9 is connected to the vehicle cabin 4 and the roll-off piston 10 is connected to the vehicle frame 3.

The cabin mounting system 2 has a valve unit 12 which serves to variably adjust the air mass in the air chamber 11 of the air spring 6. To this end, the valve unit 12 has an inlet valve 13 for supplying air mass and an outlet valve 14 for discharging air mass. For example, the inlet valve 13 and the outlet valve 14 are formed, respectively, as a switching valve with two discrete switching states which are integrated in the roll-off piston 10.

The cabin mounting system 2 has an electronic controller 15 for regulating and/or controlling the valve unit 12 which is signally connected to the inlet valve 13 and the outlet valve 14 via signal lines 16. For example, the controller 15 is formed as a so-called electronic cabin air leveling module (eCALM).

Further, the cabin mounting system 2 has a position sensing system 17 which is formed to detect a relative position between the vehicle frame 3 and the vehicle cabin 4. For example, the position sensing system 17 has at least one position sensor 18 which is formed to detect a relative position or absolute position of the vehicle cabin 4 relative to the vehicle frame 3. For example, the position sensor 18 is formed as a magnetic and/or inductive and/or optoelectronic sensor. The position sensor 18 is signally connected to the controller 15 by a further signal line 19 in order to convey the detected relative position or the relative position or absolute position of the vehicle cabin 4 to the controller 15.

The controller 15 is formed to control the valve unit 12 based on the relative position, e.g., by an algorithm executed on the controller 15, in order, for example, to level, lower or raise the vehicle cabin 4 to various levels. For example, it can be decided on the basis of the relative position whether to supply or remove air mass from the air spring 6, and the inlet valve 13 or the outlet valve 14 are actuated or controlled to this end via the signal lines 16.

To this end, the air spring 6 must be supplied with air mass and, in vehicles with existing compressed air systems, the latter need merely be connected to the air spring 6. If there is no such compressed air system, it must be implemented separately, and the compressed air system must be actively supplied with energy for generating compressed air. Therefore, a compressed air system is suggested for a cabin mounting system 2 which need no longer be actively supplied with energy. To this end, the cabin mounting system 2 has a passive compressed air generator 5 which delivers air mass for the air spring 6 based on a relative movement between the vehicle frame 3 and the vehicle cabin 4.

According to the configuration, the compressed air generator 5 is a double-acting air piston pump that substantially comprises a cylinder 20 and a piston 22 which is fastened to a piston rod 21 and is guided along an inner wall inside of the cylinder 20. The compressed air generator 5 is arranged between the vehicle frame 3 and vehicle cabin 4, and the cylinder 20 is movement-coupled with the vehicle frame 3 on one side and the piston rod 21 is movement-coupled with the vehicle cabin 4 on the other side.

The piston 22 divides the cylinder 20 into a first working chamber 23 and a second working chamber 24. The two working chambers 23, 24 are connected, respectively, via an input-side compressed air line 25 to an air mass storage 27 which stores the air mass generated by the compressed air generator 5 and provides it to the air spring 6. To this end, the air mass storage 27 is connected to the inlet valve 12 of the air spring 6 via an output-side compressed air line 26.

Further, the first working chamber 23 of the compressed air generator 5 is connected to the environment or atmosphere via a first inlet valve 28 and to the air mass storage 27 via a first outlet valve 30. The second working chamber 24 is connected to the environment or atmosphere via a second inlet valve 29 and to the air mass storage 27 via a second outlet valve 31. The two outlet valves 31 are collectively connected to the air mass storage 27 via the input-side compressed air line 25.

The air mass storage 27 further has a filling valve 33. The air mass storage 27 can be filled initially via the filling valve 33. The filling valve 33 is suitable, for example, for connecting an external compressed air source, e.g., a compressor, so that the air mass storage 27 can be pre-filled or can be refilled as needed.

The compressed air generator 5 is arranged between the vehicle frame 3 and the vehicle cabin 4 in such a way that air mass is delivered during a relative rolling motion between the vehicle frame 3 and vehicle cabin 4 around a vehicle longitudinal axis (x axis) as well as during a relative pitching motion between the vehicle frame 3 and vehicle cabin 4 around a vehicle transverse axis (y axis). To this end, the compressed air generator 5 is arranged in a front area of the vehicle cabin 4 so as to be offset with respect to the vehicle longitudinal axis (x axis) and vehicle transverse axis (y axis). The vibration damper 7 is arranged in a rear area of the vehicle cabin 4, and the air spring 6 is arranged between the compressed air generator 5 and the vibration damper 7. For example, an air spring 6, a vibration damper 7 and a compressed air generator 5 can be arranged on each side of the vehicle in a mirror-symmetrical matter particularly with reference to the x axis.

In a driving operation, the relative movements are translated into a relative lifting movement between cylinder 20 and piston rod 21. When the piston rod 21 moves into the cylinder 20, air mass flows via the first inlet valve 28 into the first working chamber 23, and the air mass located in the second working chamber 24 is compressed by the piston 22 simultaneously and flows out via the second outlet valve 31 as air mass and is stored in the air mass storage 27. When the piston rod 21 moves out of the cylinder 20, air mass flows via the second inlet valve 29 into the second working chamber 24, and the air mass located in the first working chamber 23 is compressed by the piston 22 simultaneously and flows out as air mass via the first outlet valve 30 and is stored in the air mass storage 27. The two inlet valve 28, 29 and the two outlet valves 30, 31 are formed, respectively, as a spring-loaded check valve which releases or blocks the flow path automatically depending on the lifting movement.

Based on the relative position, the controller is formed to convert a level control or a tilt control of the vehicle cabin 4 relative to the vehicle frame 3 by correspondingly controlling or regulating the valve unit 12. For example, the inlet valve 13 is opened when the outlet valve 14 is closed, so that the air mass can flow into the air chamber 11 from the air mass storage 27, as a result of which the air spring 6 is raised and/or a damping force is increased. For example, the outlet valve 14 is opened when the inlet valve 13 is closed so that the air mass can flow out of the air chamber 11 into the environment, as a result of which the air spring 6 is lowered.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A vehicle comprising:
a vehicle frame;
a vehicle cabin movably mounted relative to the vehicle frame; and
a cabin mounting system, comprising:
at least one air spring arranged between the vehicle frame and the vehicle cabin;
a valve unit;
an air mass in the air spring is variably adjustable via the valve unit;
a position sensing system configured to detect a relative position between the vehicle cabin and the vehicle frame;
a controller configured to control the valve unit of the air spring based on the relative position; and
at least one passive compressed air generator configured to deliver air mass for the air spring based on a relative movement between the vehicle frame and the vehicle cabin.

17. The vehicle according to claim 16, wherein the compressed air generator is movement-coupled with the vehicle frame and vehicle cabin such that the compressed air generator delivers air mass during a relative rolling motion and/or a relative pitching motion between the vehicle frame and vehicle cabin.

18. The vehicle according to claim 16, wherein the compressed air generator is an air pump.

19. The vehicle according to claim 16,
wherein the compressed air generator has a cylinder and a piston which is guided in the cylinder via a piston rod and which divides the cylinder into a first working chamber and a second working chamber, and
wherein at least one of the working chambers is connected to an environment via an inlet valve and the other working chamber is connected at least indirectly to the air spring via an outlet valve.

20. The vehicle according to claim 19,
wherein the compressed air generator is a double-acting piston air pump,
wherein the first working chamber is connected to an environment via a first inlet valve and is at least indirectly connected to the air spring via a first outlet valve, and
wherein the second working chamber is connected to an environment via a second inlet valve and is at least indirectly connected to the air spring via a second outlet valve.

21. The vehicle according to claim 20,
wherein the cabin mounting system has an air mass storage for intermediate storage of the air mass generated by the compressed air generator,
wherein the air mass storage is pneumatically connected to the compressed air generator via an input-side compressed air line and to the air spring via an output-side compressed air line.

22. The vehicle according to claim 21, wherein a first outlet valve and/or a second outlet valve of the compressed air generator are connected to the air mass storage via the input-side compressed air line.

23. The vehicle according to claim 21, wherein the air mass storage has a filling valve for external filling and/or pre-filling of the air mass storage with air mass.

24. The vehicle according to claim 21, wherein the valve unit of the air spring has an inlet valve and an outlet valve, wherein the controller is formed to actuate the inlet valve or the outlet valve for raising or lowering the air spring.

25. The vehicle according to claim 24, wherein the inlet valve of the air spring is directly connected to the air mass storage via the output-side compressed air line.

26. The vehicle according to claim 20, wherein the cabin mounting system has an overpressure valve connected between the compressed air generator and the air spring.

27. The vehicle according to claim 16, wherein the controller is configured to implement a level control and/or a tilt control of the vehicle cabin by controlling and/or regulating the valve unit of the air spring.

28. The vehicle according to claim 16, wherein the cabin mounting system has at least one vibration damper for vibration-damped support of the vehicle cabin at the vehicle frame, wherein the vibration damper is coupled with the vehicle frame on one side and with the vehicle cabin on an other side.

29. The vehicle according to claim 26, wherein the compressed air generator is arranged in a front area considered in driving direction and a vibration damper is arranged in a rear area.

30. The vehicle according claim 16, wherein the vehicle is a utility vehicle or a construction machine or an agricultural machine.
